(19) United States
(12) Patent Application Publication
(10) Pub. No.: US 2005/0020289 A1
(43) Pub. Date: Jan. 27, 2005

(54) Method for blocking spam messages in a mobile communication terminal

(75) Inventors: Byung-Wook Kim, Seoul (KR); Kyung-Sook Kim, Suwon-shi (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., KYUNGKI-DO (KR)

(21) Appl. No.: 10/626,682

(22) Filed: Jul. 24, 2003

(51) Int. Cl. H04Q 7/20

(52) U.S. Cl. 455/466

(57) ABSTRACT

Disclosed is a method for blocking SMS spam messages in an SMS server or a mobile terminal. If the server receives an SMS message to be transmitted to a subscriber from a base station, it is determined if a spam blocking option is set. If the spam blocking option is set, a spam-blocking database is accessed to search for a phone number corresponding to the received message, so as to check whether the number is registered in the database. If the SMS message phone number is registered in the spam-blocking database, the procedure is ended without SMS message-processing for the message, so that spam messages are blocked from being transferred to the subscriber. If the terminal receives an SMS message, a spam-blocking database in the mobile terminal is accessed to determine if the received message is an SMS spam message. If the received message is an SMS spam message, the terminal is controlled not to notify receipt of the message.

### BACKGROUND OF THE INVENTION

1. Field of the Invention

The present invention relates to a method for blocking unsolicited commercial or advertising messages so as to prevent a subscriber of a mobile wireless terminal from receiving them, and more particularly to a method for allowing spam messages to be blocked by an SMS (Short Message Server) server, or in a mobile wireless terminal itself.

2. Description of the Related Art

A current mobile wireless terminal such as a mobile phone has no function to block a text message, irrespective of whether or not the subscriber (or recipient) wants to receive it, once it is transmitted to the subscriber's phone number. Especially, there is no way to block SMS commercial or advertising messages (hereinafter also referred to as “SMS spam messages”) which have recently gained widespread use. It is very troublesome for the terminal's subscriber to have to check such a message he or she received without notice to determine if it is spam. This may also persuade the subscriber to phone a call back number incurring VAT charges, which causes emotional damage, as well as financial damage, to the subscriber. These problems occur because, once a calling party transmits a message to a subscriber of a mobile wireless terminal, the subscriber has no choice but to receive it, irrespective of his or her desires. Thus, there is a need to protect the subscriber from such a damage and inconvenience.

### SUMMARY OF THE INVENTION

Therefore, the present invention has been made in view of the above problems, and it is an object of the present invention to provide a method for blocking an unsolicited or spam message, so as to prevent a subscriber of a mobile wireless terminal from having to check the message if he or she does not want to receive it.

In accordance with one aspect of the present invention, the above and other objects can be accomplished by the provision of a method for blocking SMS (Short Message Service) spam messages in an SMS server, comprising the steps of a), when an SMS message to be transmitted to a subscriber of a mobile wireless terminal is received from a base station, checking whether a spam blocking option is set; b), when the checked result of step a) is affirmative, gaining access to a spam-blocking information database, and searching for a phone number corresponding to the received message to check whether the phone number corresponds to a phone number registered in the spam-blocking information database; and c), when the checked result of step b) is affirmative, finishing the procedure for the received message without performing message processing for SMS services on the received message, so that SMS spam messages are blocked from being transferred to the terminal's subscriber.

In accordance with another aspect of the present invention, there is provided a method for blocking spam messages in a mobile wireless terminal, comprising the steps of a), when an SMS message is received, gaining access to a database of previously-registered, spam-blocking information to check whether the received message is an SMS spam message; and b), when the checked result of step a) is affirmative, controlling the terminal so as not to notify receipt of the message.

### BRIEF DESCRIPTION OF THE DRAWINGS

The above and other objects, features and other advantages of the present invention will be more clearly understood from the following detailed description taken in conjunction with the accompanying drawings, in which:

FIG. 1 schematically shows the configuration of an SMS (Short Message Service) system to which the present invention is applied;

FIG. 2 shows the configuration of a mobile wireless terminal to which the present invention is applied;

FIG. 3 shows display states of the screen of a mobile wireless terminal when a user or subscriber operates the terminal to register or delete a to-be-blocked phone number or word in order to block such a spam message, according to first and second embodiments of the present invention;

FIG. 4 is a flowchart illustrating a method for registering a to-be-blocked phone number in the SMS server according to an embodiment of the present invention;

FIG. 5 is a flowchart illustrating a method for blocking spam messages in the SMS server according to the first embodiment of the present invention;

FIG. 6 shows a teleservice-layer message format employed in the embodiment of the present invention; and

FIG. 7 is a flowchart showing a method for blocking spam messages in a mobile wireless terminal according to the second embodiment of the present invention.

### DETAILED DESCRIPTION OF THE PREFERRED EMBODIMENTS

Now, preferred embodiments of the present invention will be described in detail with reference to the annexed drawings. Although the following description has been made with reference to specific details such as a message containing specific content (for example, a warning message), it is only for illustrative purposes, and those skilled in the art will appreciate that the present invention can be carried out without employing such specific details. In the following description, a detailed description of known functions and configurations incorporated herein will be omitted when it may make the subject matter of the present invention rather unclear.

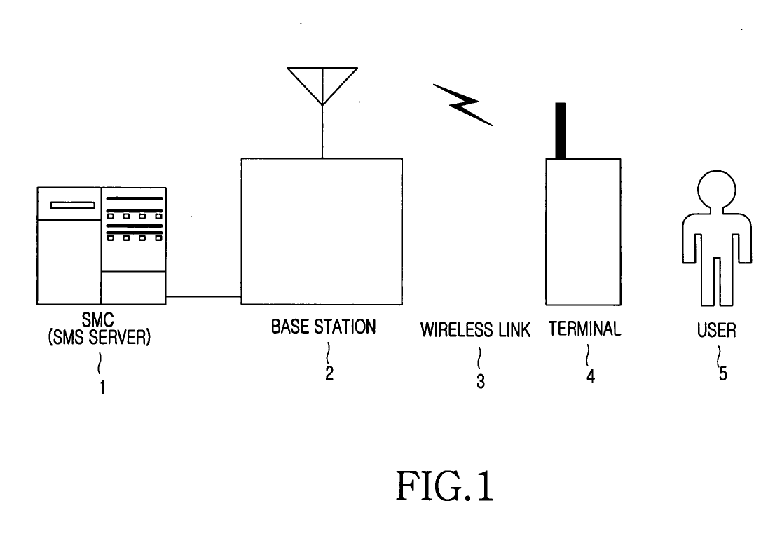

FIG. 1 schematically shows the configuration of an SMS (Short Message Service) system to which the present invention is applied.

As shown in this drawing, an SMS server 1 is connected by wire to a base station 2. The base station 2 is connected to a mobile wireless terminal 4 through a wireless link 3. Using the terminal 4, a subscriber 5 can implement a database for storing information for blocking spam massages (hereinafter also referred to as “spam-blocking information database”) in the SMS server 1, or can implement it in the terminal 4 itself.

Spam-blocking information to be stored in the spam-blocking information database includes words (for example, “advertisement” or “commercial”) that imply an unsolicited message to be blocked from a viewpoint of the subscriber, or includes a receipt-refusal phone number (i.e., a phone number to be blocked).

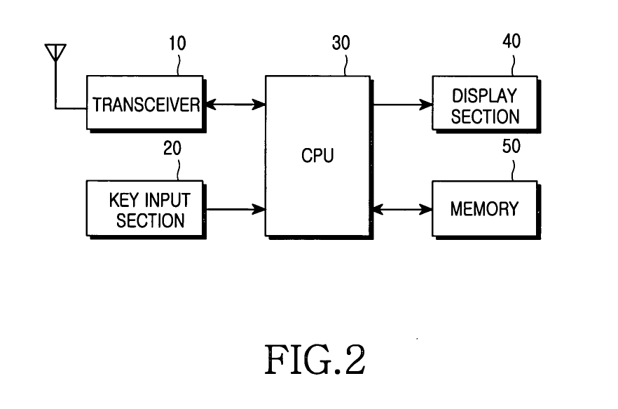

FIG. 2 shows the configuration of a mobile wireless terminal to which the present invention is applied.

The terminal includes a transceiver 10, a key input section 20, a CPU (Central Processing Unit) 30, a display section 40, and a memory 50. The transceiver 10 performs processes for transmitting or receiving wireless signals. The key input section 20, as user interface means, has a number of keys including number and function keys. Using these keys, a subscriber can enter phone numbers he or she wants to block, so as to prevent receipt of spam messages. The CPU 30 controls the overall operation of the terminal. In addition, based on a previously-stored program and data for blocking spam messages (also referred to as “spam-blocking program and data”), the CPU controls a spam-blocking operation according to an embodiment of the present invention. The display section 40 is a user interface means that may be composed of a liquid crystal display device or the like. Using this display section 40, the subscriber can check a message received by the terminal, or can check the state of the terminal. The memory 50, as a spam-blocking information database, stores words that imply unsolicited messages, phone numbers, or the like, to be blocked from a viewpoint of the subscriber. The memory 50 may further include a region for storing a warning message. The warning message may include, for example, a message “ - - - you will be prosecuted if you resend me a message like this, and - - - ”. The warning message can be used to warn a spam sender, such that it is transmitted to a calling party when the calling party repeatedly sends a spam mail or message to the subscriber disregarding the receipt refusal thereof.

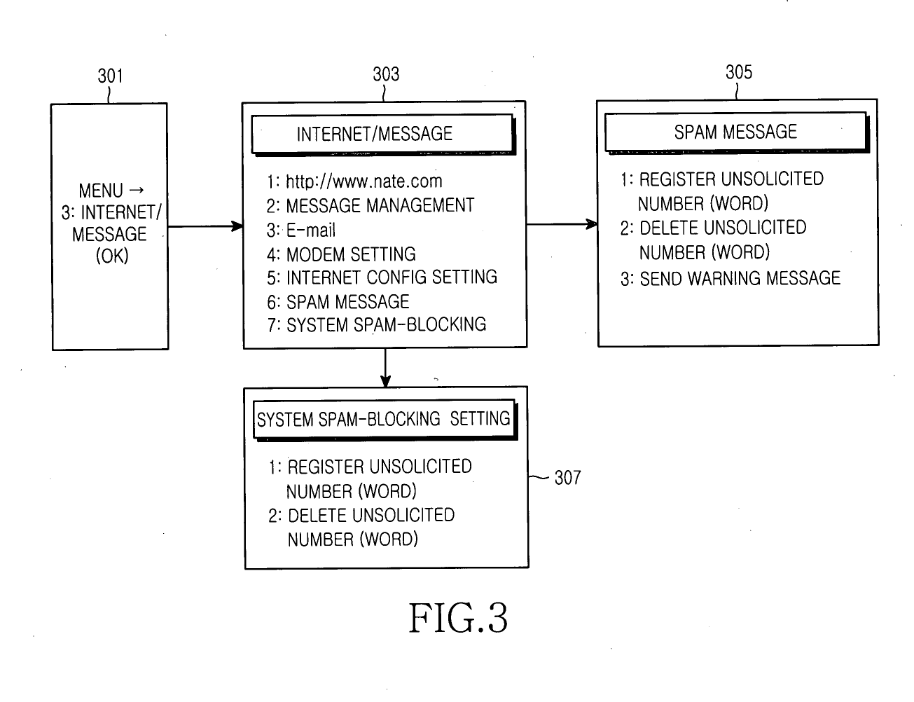

FIG. 3 shows display states of the screen of a mobile wireless terminal when a user or subscriber operates the terminal to register or delete a to-be-blocked phone number or word in order to block such a spam message, according to first and second embodiments of the present invention.

As shown in this drawing, when the subscriber selects a menu item “3: Internet/message” in a first menu screen “Menu” of the wireless mobile terminal (or mobile phone), a second menu screen “Internet/Message” including 7 menu items is displayed as denoted by an arrow on the right side of the first menu screen “MENU”. Among the 7 items, a 6th item “6: spam message” is used to allow the terminal itself to generate a spam-blocking information database, while a 7th item “7: system spam-blocking setting” is used to generate the spam-blocking information database in an SMS server.

In detail, when the item “6: spam message” is selected, a third menu screen “Spam Message” including three menu items is displayed as denoted by an arrow on the right side of the second menu screen “Internet/Message”. While the third menu screen is displayed, selection of a first item “register unsolicited phone number (word)” allows the subscriber to register an unsolicited phone number or word to be blocked, and selection of a second item “delete unsolicited phone number (word)” allows the subscriber to delete the registered unsolicited phone number or word, and further selection of a third item “send warning message” allows the subscriber to send a warning message.

Similarly, when the 7th item “7: system spam-blocking setting” of the second menu screen “Internet/Message” is selected, a fourth menu screen “System Spam-Blocking Setting” including two menu items is displayed as denoted by a downward arrow on the down side of the second menu screen “Internet/Message”. While the fourth menu screen is displayed, selection of a first item “register unsolicited phone number (word) allows the subscriber to register an unsolicited phone number or word to be blocked in the spam-blocking information database of the SMS server, and selection of a second item “delete unsolicited phone number (word)” allows the subscriber to delete the registered unsolicited phone number or word.

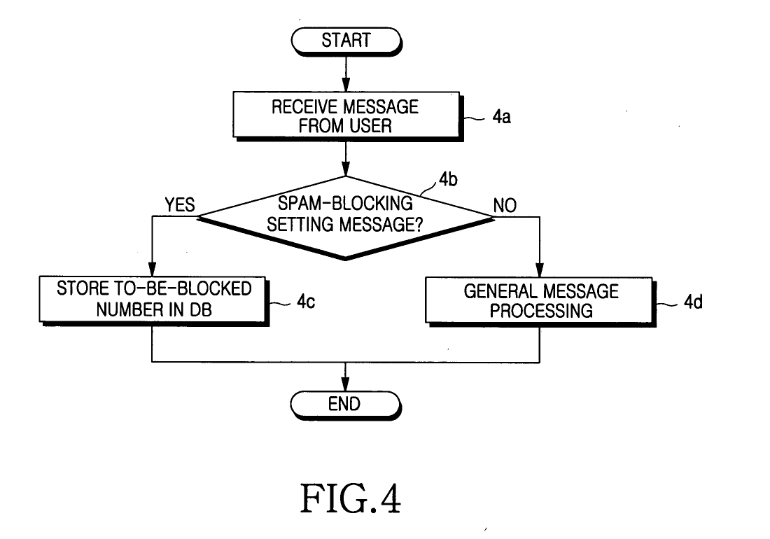

FIG. 4 is a flowchart illustrating a method for registering a to-be-blocked phone number (also referred to as “unsolicited phone number”) in the SMS server according to an embodiment of the present invention.

If the subscriber inputs spam-blocking information and instructs its transmission using the key input section 20 in the mobile wireless terminal, the information is transmitted to the SMS server through the base station. When the SMS server receives a message from the base station at step 4a, it is checked whether the received message is a message for spam-blocking setting (also referred to as “spam-blocking setting message”) at step 4b. When the checked result of step 4b is affirmative, a phone number to be blocked is detected from the spam-blocking setting message, and then stored in the spam-blocking information database at step 4c. On the contrary, when the checked result of step 4b is not affirmative, the SMS server performs message processing for a general SMS service at step 4d.

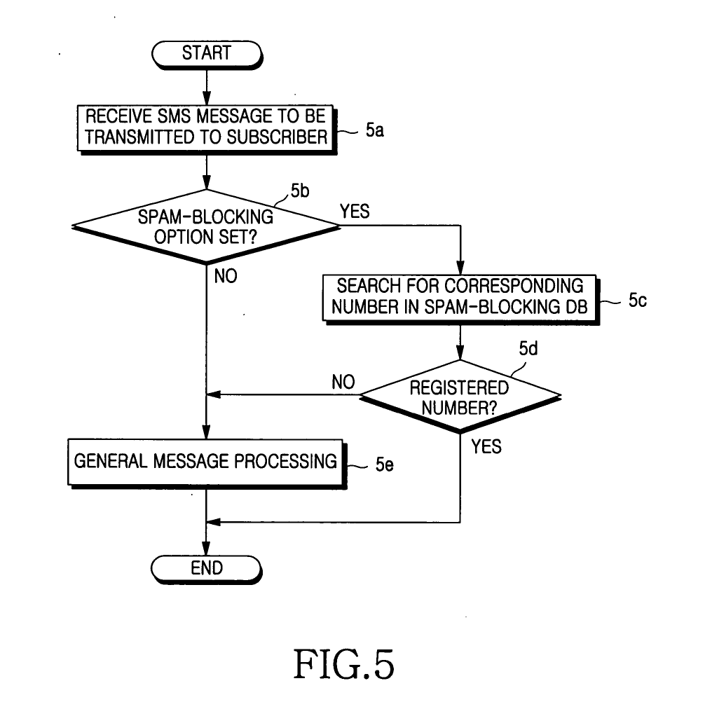

FIG. 5 is a flowchart illustrating a method for blocking spam messages in the SMS server according to the first embodiment of the present invention.

When, at step 5a, the SMS server receives an SMS message that is transmitted toward a called-party subscriber of a mobile wireless terminal from a calling party subscriber, it is checked at step 5b whether a spam blocking option is set. When the checked result of step 5b is affirmative, the spam-blocking information database is accessed to search for a phone number corresponding to the received message at step 5c. As a result of the search, it is checked at step 5d whether the phone number corresponds to a phone number registered in the spam-blocking information database. When the checked result of step 5d is affirmative, it means that the received message is an unsolicited message to be blocked, so the procedure is finished without performing message processing on the received message. On the contrary, when the checked result of step Sd is not affirmative, message processing is performed on the received message for providing a general SMS service at step Se.

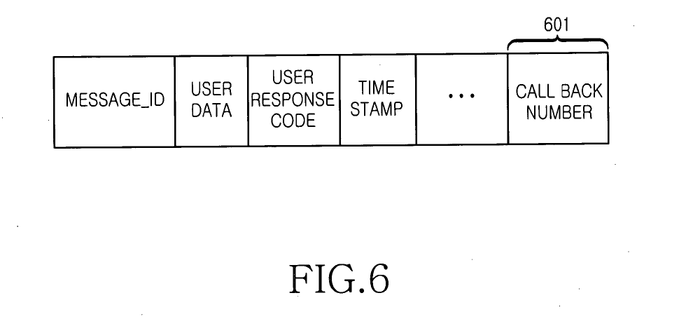

FIG. 6 shows a teleservice-layer message format employed in the embodiment of the present invention.

Definition of each field in the format can be referred to ITA/ETA-637-A, and, in particular, a call back number field shown in FIG. 6 is important in realizing the present invention.

An SMS message is included in a teleservice layer of a message downloaded from a base station, which is classified into voice and text messages. The text message includes a phone number (a calling-party phone number, i.e., a call back number) as well as the text content of the message. Accordingly, the phone number is detected and stored in a buffer, and, referring to the spam-blocking information database, it is used to determine whether to notify an incoming call thereof, or to send a warning message.

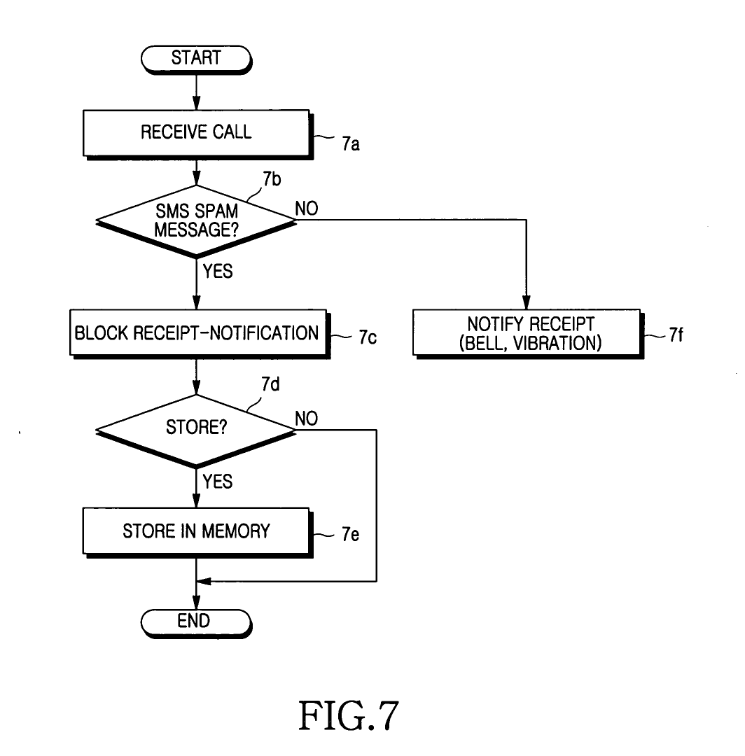

FIG. 7 is a flowchart showing a method for blocking spam messages in a mobile wireless terminal according to the second embodiment of the present invention.

When the terminal receives a call, the CPU 30 detects it at step 7a, and checks at step 7b whether the received message is a spam message, i.e., an SMS spam message (or a not-shown unsolicited phone number to be blocked). To this end, for example, the CPU 30 determines whether a call back number in the message contains a number, such as “700” or “0600”, commonly included in commercial phone numbers incurring high charges, or the CPU 30 searches for a word such as “advertisement” or “commercial” in the text message. It will be appreciated by those skilled in the art that the spam-blocking accuracy can be increased in such a manner that the two determination processes are sequentially performed, and the received message is then considered an SMS spam message only if one of the two determination results is affirmative, as well as when both of them are affirmative.

When the checked result of step 7b is affirmative, the CPU controls the terminal to disregard the received message and not to notify the receipt of the message at step 7c. Subsequently, at step 7d, it is checked whether the received message is set to be stored. This step intends to prevent a non-spam message from being blocked by mistake. When the checked result of step 7d is affirmative, the received message is stored in the memory 50 at step 7e.

When the checked result of step 7b is not affirmative, the receipt of the message is notified to the subscriber through known notification means, such as a bell sound or vibration at step 7f.

As apparent from the above description, according to the present invention, it is possible to effectively block SMS spam messages, thereby protecting users' privacy and preventing financial damage. In other words, there is no inconvenience for users to have to check and delete unsolicited commercial messages, because they can avoid receiving such messages. In addition, it is possible to prevent a user from phoning a call back number in a received message without knowing who sent the message, believing the received message might not be a spam message, thereby not incurring phone charges thereof. Further, separate storing means to store such a message is provided to prevent a non-spam message from being discarded by mistake.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method for blocking SMS (Short Message Service) spam messages in an SMS server, comprising the steps of:
a) when an SMS message and its corresponding SMS message phone number to be transmitted to a subscriber of a mobile communication terminal is received from a base station, determining if a spam blocking option is set;
b) if the spam blocking option is set, accessing a spam-blocking information database, and searching for the SMS message phone number to determine the SMS message phone number is registered in the spam-blocking information database; and
c) if the SMS message phone number is registered in the spam-blocking information database, ending the procedure for the received message without performing message processing for SMS services on the received message.

2. A method for blocking SMS (Short Message Service) spam messages in an SMS server, comprising the steps of:
a) when an SMS message to be transmitted to a subscriber of a mobile communication terminal is received from a base station, determining if a spam blocking option is set;
b) if the spam blocking option is set, determining if the received message includes a predetermined word, said predetermined word being prestored in a spam-blocking information database; and
c) if the received message includes a predetermined word, ending the procedure for the received message without performing message processing for SMS services on the received message.

3. A method for blocking spam messages in a mobile communication terminal, comprising the steps of:
a) when an SMS message is received, accessing a database of previously-registered, spam-blocking information to determine if the received message is an SMS spam message; and
b) when it is determined that the received message is a spam message, controlling the terminal so as not to notify receipt of the message.

4. The method as set forth in claim 3, further comprising the step of:
c) determining if a spam message is set to be stored, after blocking the message-receipt notification, and storing the received SMS spam message if it is determined that the spam message is to be stored.

5. The method as set forth in claim 3, wherein a phone number of an SMS spam-message sender is registered in the spam-blocking information database, and step a) further includes the step of:
a-1) detecting an SMS message phone number from the received SMS message, and determining if the SMS message phone number is registered in the spam-blocking information database.

6. The method as set forth in claim 3, wherein a predetermined word is registered in the spam-blocking information database, and step a) further includes the step of:
a-2) determining if the registered predetermined word is included in the received SMS message.

7. The method as set forth in claim 3, wherein a phone number of an SMS spam message sender and a predetermined word implying an SMS spam message are registered in the spam-blocking information database, and step a) further includes the steps of:
a-1) detecting an SMS message phone number from the received SMS message, and determining if the SMS message phone number is registered in the spam-blocking information database; and
a-2) determining if the registered predetermined word is included in the received SMS message.

8. The method as set forth in claim 3, further comprising the step of:
d) reading a previously stored warning message, from the database, and transmitting the previously stored warning message to a call back number detected from the SMS message.
